(19) United States
(12) Patent Application Publication
(10) Pub. No.: US 2025/0004106 A1
(43) Pub. Date: Jan. 2, 2025

(54) ELECTRONIC DEVICE AND DETERMINATION METHOD

(71) Applicant: Lenovo (Beijing) Limited, Beijing (CN)

(72) Inventor: Yu-Che LIN, Beijing (CN)

(21) Appl. No.: 18/755,053

(22) Filed: Jun. 26, 2024

(30) Foreign Application Priority Data
Jun. 30, 2023 (CN) 202310803017.X

(51) Int. Cl. G01S 7/48; G01N 27/22

(52) U.S. Cl. CPC G01S 7/4802; G01N 27/228

(57) ABSTRACT

An electronic device includes a target metal segment, a first sensing circuit, and a second sensing circuit. The first sensing circuit is connected to the target metal segment and obtains a first parameter based on a first sensing signal of the target metal segment. The first parameter is used to indicate a distance between a target object and the target metal segment. The second sensing circuit is connected to the target metal segment and obtains a second parameter based on a second sensing signal of the target metal segment. The second parameter is used to indicate a type of the target object.

### CROSS-REFERENCE TO RELATED APPLICATION

The present disclosure claims priority to Chinese Patent Application No. 202310803017.X, filed on Jun. 30, 2023, the entire content of which is incorporated herein by reference.

### TECHNICAL FIELD

The present disclosure is related to the human body sensing technology field and, more particularly, to an electronic device and a determination method.

### BACKGROUND

Sensing apparatuses applied in existing electronic devices such as cell phones are mainly capacitive sensing chips. However, the capacitive sensing chips respond to all objects. That is, whether a human body or other objects such as a metal product approaches an electronic device, the capacitance of the capacitive sensing chip is increased, which causes false determination of the sensing apparatus. Thus, with the existing technology, it is difficult to determine whether the object approaching the electronic device is a human body or a non-human body.

### SUMMARY

An aspect of the present disclosure provides an electronic device, including a target metal segment, a first sensing circuit, and a second sensing circuit. The first sensing circuit is connected to the target metal segment and obtains a first parameter based on a first sensing signal of the target metal segment. The first parameter is used to indicate a distance between a target object and the target metal segment. The second sensing circuit is connected to the target metal segment and obtains a second parameter based on a second sensing signal of the target metal segment. The second parameter is used to indicate a type of the target object.

An aspect of the present disclosure provides a determination method. The method includes obtaining a first parameter, obtaining a second parameter, and determining a target type of the target object based on the first parameter and the second parameter. The first parameter is used to indicate a distance between a target object and a target metal segment. The second parameter is used to indicate a type of the target object.

### BRIEF DESCRIPTION OF THE DRAWINGS

FIG. 1 illustrates a schematic structural diagram of an electronic device according to some embodiments of the present disclosure.

FIG. 2 illustrates a schematic diagram showing a connection between a first sensing circuit and a target metal segment according to some embodiments of the present disclosure.

FIG. 3 illustrates a schematic diagram showing a connection between a second sensing circuit and a target metal segment according to some embodiments of the present disclosure.

FIG. 4 illustrates a schematic structural diagram of another electronic device according to some embodiments of the present disclosure.

FIG. 5 illustrates a schematic diagram showing a connection between a radio frequency (RF) circuit and a target metal segment according to some embodiments of the present disclosure.

FIG. 6 illustrates a schematic principle diagram showing a first sensing circuit sensing a target object according to some embodiments of the present disclosure.

FIG. 7 illustrates a schematic diagram showing a target object being connected to a first sensing circuit in series as a capacitor according to some embodiments of the present disclosure.

FIG. 8 illustrates a schematic principle diagram showing a second sensing circuit sensing a target object according to some embodiments of the present disclosure.

FIG. 9 illustrates a schematic flowchart of a determination method according to some embodiments of the present disclosure.

### REFERENCE NUMERALS

| | | |
|---|---|---|
| 1 Target metal | 2 First sensing | 3 Second sensing |
| segment | circuit | circuit |
| 4 Radio frequency | 21 Capacitor | 22 Resistance |
| (RF) circuit | sensor | |
| 23 First inductive | 31 Low-frequency | |
| coil | transceiver | |
| 32 Second inductive | 41 Radio frequency | |
| coil | (RF) transceiver | |
| 42 Capacitor | | |

### DETAILED DESCRIPTION OF THE EMBODIMENTS

The technical solutions and features of the present disclosure are described according to the accompanying drawings.

Various modifications can be made to embodiments of the present disclosure. The specification is not considered limiting but is used as examples of embodiments of the present disclosure. Those skilled in the art can think of other modifications within the scope and spirit of the present disclosure.

Some accompanying drawings can be included in the specification, form a part of the specification, and show some embodiments of the present disclosure. The accompanying drawings can be used to describe the principle of the present disclosure with the general description of the present disclosure above and the detailed description of embodiments of the present disclosure below.

Embodiments of the present disclosure are described exemplarily according to the accompanying drawings. Features of the present disclosure can become obvious.

Although the present disclosure is described according to specific examples, those skilled in the art can implement many other equivalent forms of the present disclosure, which include features of the claims and are within the scope of the present disclosure.

In connection with the accompanying drawings and the following detailed description, the above and other aspects, features, and advantages of the present disclosure can become more obvious.

Embodiments of the present disclosure are described according to the accompanying drawings. However, embodiments of the present disclosure are merely examples of the present disclosure and can adopt a plurality of implementations. Well-known and/or repeated functions and structures are not described in detail to avoid unnecessary or redundant details that would obscure the present disclosure. Therefore, the specific structural and functional details of the present disclosure are not intended to limit the present disclosure but are merely used as a basis and representative basis for teaching those skilled in the art to use the present disclosure in substantially any appropriate detailed structures.

In the specification, phrases such as “in one embodiment,” “in another embodiment,” “in yet another embodiment,” or “in other embodiments” can refer to one or more embodiments of same or different embodiments of the present disclosure.

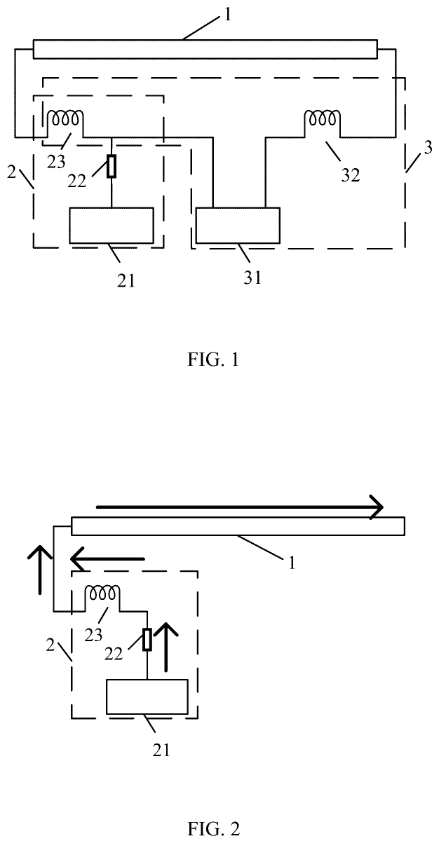

To facilitate understanding of the present disclosure, an electronic device of embodiments of the present disclosure is described in detail. FIG. 1 illustrates a schematic structural diagram of the electronic device according to some embodiments of the present disclosure.

As shown in FIG. 1, the electronic device of embodiments of the present disclosure includes a target metal segment 1. This target metal segment 1 can be any metal segment of the electronic device, such as an antenna of a circuit board or a metal frame of the electronic device. In some embodiments, the electronic device can include a cell phone, a remote controller, etc.

Further, as shown in FIG. 1, the electronic device of embodiments of the present disclosure further includes a first sensing circuit 2. The first sensing circuit 2 is connected to the target metal segment 1. A first parameter can be obtained based on a first sensing signal of the target metal segment 1. As shown in FIG. 1, an end of the first sensing circuit 2 is connected to the target metal segment 1. When the first sensing circuit 2 operates, the first sensing circuit 2 can transmit the first sensing signal to the target metal segment 1. The first sensing signal can be a current signal. After the target metal segment 1 receives the first sensing signal, the first sensing circuit 2 can monitor the parameter change of the first sensing circuit 2 to obtain the first parameter.

The first parameter can be used to indicate a distance between the target object and the target metal segment 1. The first parameter can include a capacitance of a capacitor sensor 21 of the first sensing circuit 2. When a first capacitance increases, the distance between the target object and the target metal segment 1 can decrease. When the first capacitance decreases, the distance between the target object and the target metal segment 1 can increase. In some other embodiments, the first parameter can include a current value in the first sensing circuit 2. Based on the inverse relationship between the capacitance and the current value, when the first parameter decreases in the first sensing circuit 2, the distance between the target object and the target metal segment 1 can decrease. When the first parameter increases in the first sensing circuit 2, the distance between the target object and the target metal segment 1 can increase.

Further, as shown in FIG. 1, the electronic device of embodiments of the present disclosure further includes a second sensing circuit 3. The second sensing circuit 3 is also connected to the target metal segment 1. The second parameter can be obtained based on the second sensing signal of the target metal segment 1. Then, two ends of the second sensing circuit 3 can be connected to two ends of the target metal segment 1, respectively. Similarly, when the second sensing circuit 3 operates, the second sensing circuit 3 can transmit the second sensing signal to the target metal segment 1. The second sensing signal can also be a current signal.

The second parameter can be used to indicate the type of the target object. The second parameter can include a current value of an induced current in the second sensing circuit 3. The type of the target object can be further determined according to a current difference between the current value of the induced current and the current value indicated by the second sensing signal.

In embodiments of the present disclosure, after obtaining the first parameter, the first sensing circuit 2 can determine whether a target object approaching or moving away from the target metal segment 1 exists. Further, after obtaining the first parameter, the first sensing circuit 2 can transmit the first parameter to the system controller of the electronic device such as an embedded controller. Thus, the system controller can determine whether the target object approaching/moving away from the target metal segment 1 exists based on the first sensing signal and the first parameter. Similarly, in embodiments of the present disclosure, after obtaining the second parameter, the second sensing circuit 3 can determine the type of the target object. Further, after obtaining the second parameter, the second sensing circuit 3 can transmit the second parameter to the system controller of the electronic device such as the embedded controller. Thus, the system controller can determine the type of the target object based on the second sensing signal and the second parameter.

In embodiments of the present disclosure, the first sensing circuit 2 and the second sensing circuit 3 can be connected to the target metal segment 1 to determine whether the target object approaching the target metal segment 1 through the first sensing circuit 2, and determine the type of the target object approaching the target metal segment 1 through the second sensing circuit 3. The type can include metal and non-metal. Thus, when the target object approaches the target metal segment 1, whether the target object is a human body can be determined accurately. The accuracy can be high. Moreover, the first sensing circuit 2 and the second sensing circuit 3 are connected to the target metal segment 1, and the volume of the electronic device may not need to be increased.

As shown in FIG. 1, the first sensing circuit 2 includes a first path, that is, the path, in which the first sensing circuit 2 transmits the first sensing signal to the target metal segment 1. The first sensing circuit 2 further includes a capacitor sensor 21. The capacitor sensor 21 is connected to the target metal segment 1 through the first path. To represent the first sensing circuit 2 clearer, FIG. 2 illustrates a schematic diagram showing a connection between the first sensing circuit and the target metal segment according to some embodiments of the present disclosure. Based on this, the first sensing circuit 2 can provide the first sensing signal for the target metal segment 1 through the first path. Meanwhile, the first sensing circuit 2 can monitor the change of the first sensing signal through the first path to obtain the first parameter.

As shown in FIG. 1 and FIG. 2, the first path of embodiments of the present disclosure includes a resistor 22 and a first inductive coil 23. That is, the first end of the capacitor sensor 21 is connected to the first end of the resistor 22. The second end of the resistor 22 is connected to the first end of the first inductive coil 23. The second end of the first inductive coil 23 is connected to the first end of the target metal segment 1. Thus, the first sensing signal provided by the capacitor sensor 21 can flow through the resistor 22 and the first inductive coil 23 to reach the target metal segment 1 in sequence. In some embodiments, the flow direction of the first sensing signal can be indicated by the flow direction pointed by an arrow in FIG. 2.

The capacitor sensor 21 can be a capacitor sensing chip. The distance between the target object and the target metal segment 1 can be determined according to the obtained first parameter. The capacitor sensor 21 can also be a capacitor element. The second end of the capacitor sensor 21 can be connected to the system controller of the electronic device to transmit the provided first sensing signal and the obtained first parameter to the system controller. Thus, the system controller can determine the distance between the target object and the target metal segment 1 based on the first sensing signal and the first parameter, which is not limited by the present disclosure.

As shown in FIG. 1, the second sensing circuit 3 includes the second path and the third path. The second path can be the path in which the second sensing circuit 3 transmits the second sensing signal to the target metal segment 1. The third path can be the path in which the target metal segment 1 transmits a feedback signal of the second sensing signal to the second sensing circuit 3. The second sensing circuit 3 further includes a low-frequency transceiver 31. The low-frequency transceiver 31 is connected to the first end of the target metal segment 1 through the second path. The low-frequency transceiver 31 is connected to the second end of the target metal segment 1 through the third path. That is, through the second path and the third path, the second sensing circuit 3 can form a closed loop with the target metal segment 1. In embodiments of the present disclosure, the second sensing circuit 3 can provide the second sensing signal for the target metal segment 1 through the second path, and meanwhile, obtain the feedback signal of the second sensing signal through the third path to obtain the second parameter. An operation frequency range of the low-frequency transceiver can range from 1 k to 100 MHz.

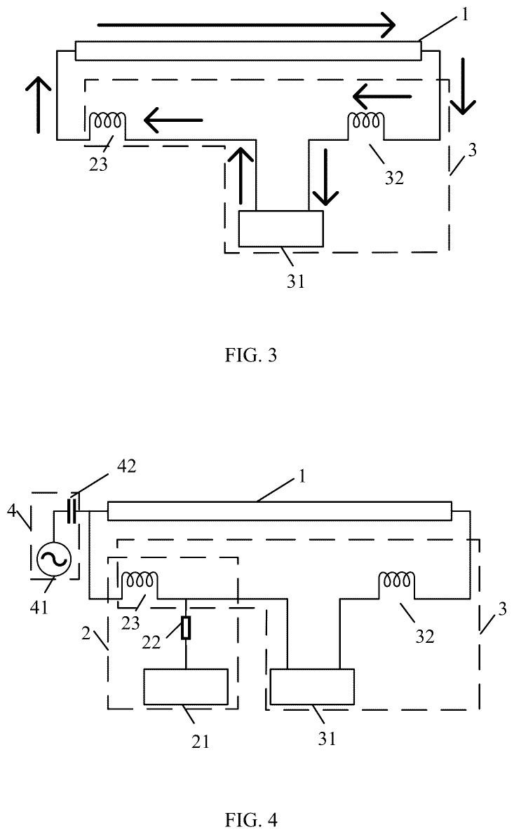

Further, FIG. 3 illustrates a schematic diagram showing the connection between the second sensing circuit and the target metal segment according to some embodiments of the present disclosure. The second sensing circuit 3 can be represented clearly. In connection with FIG. 1 and FIG. 3, the second path includes the first inductive coil 23. The third path includes the second inductive coil 32. The first inductive coil 23 can be the same as the second inductive coil 32. That is, the first end of the low-frequency transceiver, the first inductive coil 23, the target metal segment 1, the second inductive coil 32, and the second end of the low-frequency transceiver 31 are connected in sequence to form the closed loop. Thus, when the low-frequency transceiver 31 provides the second sensing signal, the target metal segment 1 can be charged to form a magnetic field to respond to the change of the outer side. The flow direction of the arrow in FIG. 3 can be the flow direction of the second sensing signal provided by the low-frequency transceiver 31.

Similarly, the low-frequency transceiver 31 can be a chip having a processing ability. The low-frequency transceiver 31 can determine the type of the target object based on the obtained second parameter. The capacitor sensor 42 can be connected to the system controller of the electronic device and transmit the second sensing information and obtain the parameters to the system controller. Thus, the system controller can determine the type of the target object based on the system controller.

FIG. 1 does not show the system controller of the electronic device.

FIG. 4 illustrates a schematic structural diagram of another electronic device according to some embodiments of the present disclosure. As shown in FIG. 4, the electronic device includes a target metal segment 1, a first sensing circuit 2, a second sensing circuit 3, and a radio frequency (RF) circuit 4.

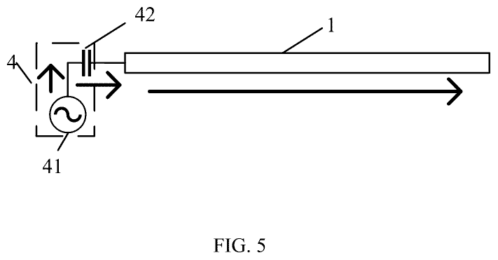

In some embodiments, the RF circuit 4 can be also connected to the target metal segment 1. When the target metal segment 1 is connected to the RF circuit 4, the target metal segment 1 can be used as an antenna radiator of the electronic device to use the target metal segment 1 to transmit the RF signal. FIG. 5 illustrates a schematic diagram showing the connection between the RF circuit and the target metal segment according to some embodiments of the present disclosure.

In embodiments of the present disclosure, the first sensing circuit 2, the second sensing circuit 3, and the RF circuit 4 can be connected to the target metal segment 1. That is, the first sensing circuit 2, the second sensing circuit 3, and the RF circuit 4 can share the same target metal segment 1, which ensures the user needs for a small volume of the electronic device, and the cost can be low.

As shown in FIG. 4 and FIG. 5, the RF circuit 4 of embodiments of the present disclosure includes an RF transceiver 41. An operation frequency of the RF transceiver 41 ranges from 600M to 6 GHz. The RF transceiver 41 is connected to the target metal segment 1 through the RF path. In some embodiments, the RF path can include a capacitor 42. That is, the RF transceiver 41 can be connected to the target metal segment 1 through the capacitor 42. Moreover, the flow direction indicated by the arrow of FIG. 5 is the flow direction of the RF signal. That is, the RF signal provided by the RF transceiver 41 can pass through the capacitor 42 and the target metal segment 1 and be transmitted to the outer side to realize the communication of the electronic device and the outer side.

In some embodiments, the first sensing circuit 2 and the second sensing circuit 3 can operate alternatively. That is, if the capacitor sensor 21 is in an operation state, the low-frequency transceiver 31 can be in a non-operation state. If the capacitor sensor 21 is in a non-operation state, the low-frequency transceiver 31 can be in an operation state.

Based on this, the resistance of the resistor 22 of embodiments of the present disclosure can range from 100 to 3000Ω. The resistor 22 can block the second sensing signal provided by the low-frequency transceiver 31 (operation frequency range of 1 kHz to 100 MHz). That is, the resistor 22 can cause the second sensing circuit 3 to be connected while the first sensing circuit 2 to be disconnected through the first sensing signal and by blocking the second sensing signal.

In embodiments of the present disclosure, the capacitance of the capacitor 42 can be set to a range from 10 to 200 pF. The capacitor 42 can allow the RF signal of the RF transceiver 41 (operation frequency range of 600M to 6 GHz) to pass through. The capacitor 42 can block the first sensing signal of the capacitor sensor 21 and a part of the second sensing signal of the low-frequency transceiver 31. Thus, the RF circuit 4 can be connected while the first sensing circuit 2 and the second sensing circuit 3 can be disconnected.

In embodiments of the present disclosure, the first inductive coil 23 and the second inductive coil 32 can be identically set. The inductances of the first inductive coil 23 and the second inductive coil 32 can range from 39 to 470 nH. The first inductive coil 23 can allow the first sensing signal of the capacitor sensor 21 and the second sensing signal from the low-frequency transceiver 31 to pass through, while blocking the RF signal of the RF transceiver 41. The second inductive coil 32 can allow the second sensing signal of the low-frequency transceiver 31 to pass through while blocking the first sensing signal from the capacitor sensor 21 and the RF signal from the RF transceiver 41.

In embodiments of the present disclosure, through the resistor 22, capacitor 42, first inductive coil 23, and second inductive coil 32, the first sensing circuit 2, the second sensing circuit 3, and the RF circuit 4 can operate normally without affecting each other while sharing the same target metal segment 1.

Then, the operation states of the first sensing circuit 2, the second sensing circuit 3, and the RF circuit 4 during the operation of the electronic device are described in detail.

After the electronic device is powered on, the RF transceiver 41 can transmit the RF signal, which can be transmitted to the target metal segment 1 via the capacitor 42. Thus, the target metal segment 1 can be used as the antenna radiator for the electronic device. That is, the RF signal can be transmitted by the target metal segment 1 to allow the electronic device to transmit the signal to the outside.

While the RF transceiver 41 transmits the RF signal, the first sensing circuit 2 and the second sensing circuit 3 can operate alternatively. For example, an alternating cycle can be predetermined to allow the first sensing circuit 2 and the second sensing circuit 3 to operate according to the alternating cycle. The alternating cycle can be determined according to one or more of an emission frequency of the RF signal, an emission frequency of the first sensing signal, or an emission frequency of the second sensing signal.

When the first sensing circuit 2 operates, the capacitor sensor 21 can be in the operation state, and the low-frequency transceiver 31 can be in the non-operation state. The capacitor sensor 21 can provide the first sensing signal, which can be transmitted to the target metal segment 1 through the resistor 22 and the first inductive coil 23. This first sensing signal can be a current. Then, the second inductive coil 32 and capacitor 42 can block the first sensing signal to prevent the first sensing signal from affecting the second sensing circuit 3 and the RF circuit 4.

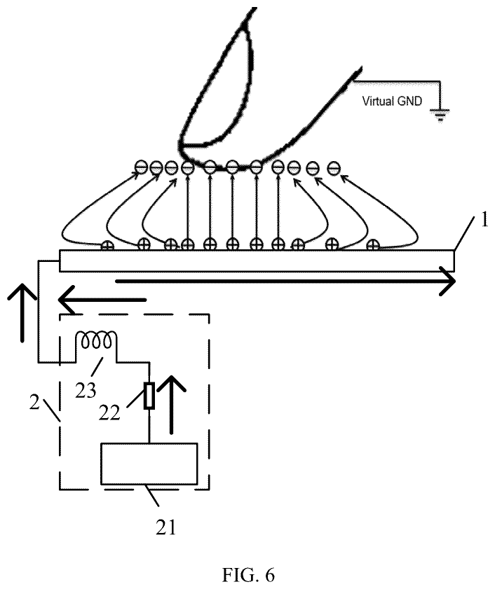

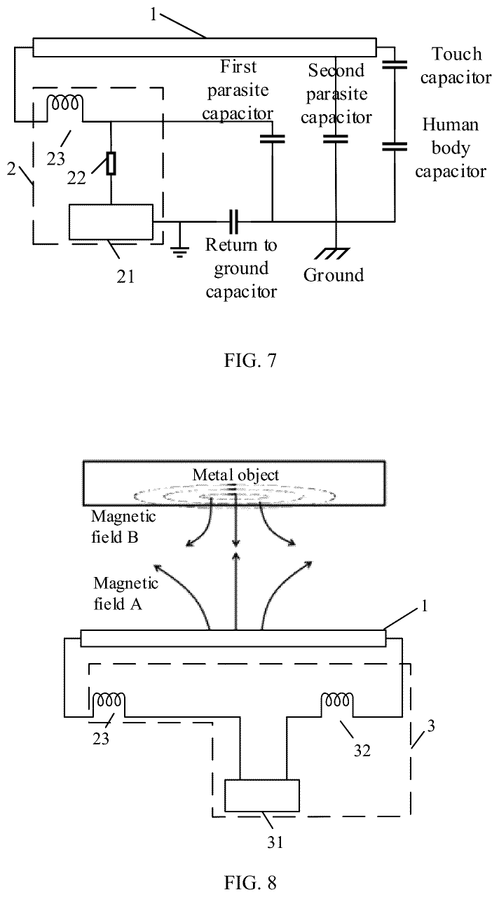

Then, the capacitor sensor 21 can monitor the capacitance of the capacitor sensor 21 in real-time. That is, the capacitance of the capacitor sensor 21 can be the first parameter obtained by the first sensing circuit 2. FIG. 6 illustrates a schematic principle diagram showing the first sensing circuit 2 sensing the target object according to some embodiments of the present disclosure. If the target object approaching the target metal segment 1 exists, a non-contact capacitive effect can be generated between the target object and the target metal segment 1, which causes the electric field of the target metal segment 1 to change. Then, the target object can be connected to the first sensing circuit 2 in series as a capacitor, which causes the capacitance in the first sensing circuit 2 to change greatly. FIG. 7 illustrates a schematic diagram showing the target object being connected to the first sensing circuit 2 in series as the capacitor according to some embodiments of the present disclosure. In some embodiments, before the target object approaches the target metal segment 1, the capacitor of the first sensing circuit 2 includes a first parasitic capacitance (parasitic capacitance of the first sensing circuit 2 to ground), a second parasitic capacitance (parasitic capacitance of the target metal segment 1 to ground), and a return-to-ground capacitance. After the target object approaches the target metal segment 1, as shown in FIG. 7, the capacitance in the first sensing circuit 2 includes the first parasitic capacitance, the second parasitic capacitance, the return-to-ground capacitance, and a touch capacitance and a human body capacitance generated based on the target object. Further, after the capacitor sensor 21 detects the change, the existence of the target object approaching the target metal segment 1 can be determined.

In addition to the distance between the target object and the target metal segment 1 causing changes in the capacitance detected by the capacitor sensor 21, other situations (e.g., signal wave in the circuit) can also cause the capacitance detected by the capacitor sensor 21 to change. Based on this, a capacitance threshold can be set. When the capacitance difference between the capacitance included in the first parameter and the capacitance corresponding to the first sensing signal is greater than the capacitance threshold, the target object can be determined to be within a certain range of the target metal segment 1. Further, the relative position relationship between the target object and the target metal segment 1 can be determined based on a plurality of capacitance differences. For example, if the capacitance difference gradually reduces, the target object can be determined to gradually approach the target metal segment 1. If the capacitance difference gradually increases, the target object can be determined to gradually move away from the target metal segment 1. Of course, the capacitance threshold can be set according to the actual needs.

In some embodiments, when the first sensing circuit 2 operates, the first sensing circuit 2 can stop operating according to the alternating cycle, while the second sensing circuit 3 can start operating. In some other embodiments, after the capacitive sensor 21 determines there is the target object approaching the target metal segment 1, the first sensing circuit 2 can be stopped directly, and the second circuit 3 can be started at the same time, which is not limited in embodiments of the present disclosure.

When the first sensing circuit 2 is stopped, and the second sensing circuit 3 is started, the capacitor sensor 21 can be in the non-operation state, and the low-frequency transceiver 31 can be in the operation state. The low-frequency transceiver 31 can provide the second sensing signal. The low-frequency transceiver 31 can include a plurality of transceiver ports. The second sensing signals can be provided to the target metal segment 1 through the plurality of transceiver ports according to different emission cycles. Thus, a plurality of second parameters can be obtained correspondingly. Thus, the efficiency of determining the type of the target object can be improved with high responsiveness.

In some embodiments, the second sensing signal of the low-frequency transceiver 31 can be transmitted to the target metal segment 1 through the first inductive coil 23 and the second inductive coil 32. The second sensing signal can be a current signal. Then, the resister 22 and the capacitor 42 can also block the second sensing signal to prevent the second sensing signal from affecting the first sensing circuit 2 and the RF circuit 4.

Then, the second parameter can be transmitted through the first inductive coil 23 or the second inductive coil 32, that is the current value of the second sensing circuit 3. Thus, the target type of the target object can be determined based on the second sensing signal and the second parameter. The target type can be metal or non-metal.

FIG. 8 illustrates a schematic principle diagram showing the second sensing circuit 2 sensing the target object according to some embodiments of the present disclosure. When the second sensing circuit 3 operates, the target metal segment 1 can generate the magnetic field A in FIG. 8. Then, when a metal object approaches the target metal segment 1, a reverse eddy current can be generated on the surface of the metal object. The eddy current can generate magnetic field B in FIG. 8. Magnetic field B can interfere with magnetic field A generated by the target metal segment 1, which causes the change in magnetic field A generated by the target metal segment 1. This interference can be either constructive or destructive. The change in the magnetic field generated by the target metal segment 1 can cause the current of the second sensing circuit 3 to change. The inductive sensor can obtain the second parameter by detecting the current value of the second sensing circuit 3 in real-time. Based on the second parameter and the second sensing signal, the target type of the target object can be determined. For example, the current value indicated by the second parameter can be different from the current value indicated by the second sensing signal, or the current difference between the current value indicated by the second parameter and the current value indicated by the second sensing signal can be greater than the current threshold. Then, the target type of the target object can be determined as metal. If the current value indicated by the second parameter is the same as the current value indicated by the second sensing signal, or the current difference between the current value indicated by the second parameter and the current value indicated by the second sensing signal is smaller than or equal to the current threshold, the target type of the target object can be determined to be non-metal.

Thus, by connecting the first sensing circuit and the second sensing circuit to the target metal segment, the first sensing circuit can be configured to determine whether the target object approaches the target metal segment, and the second sensing circuit can be configured to determine the type of the target object approaching the target metal segment. Thus, when the target object approaches the target metal segment, whether the target object is a human body can be accurately determined with a high accuracy. Meanwhile, the RF circuit can be connected to the target metal segment, and the target metal segment can be used as the antenna radiator of the electronic device to transmit the RF signal of the RF circuit without enlarging the volume of the electronic device. Moreover, with the resistor, capacitor, first inductive coil, and second inductive coil, the first sensing circuit, the second sensing circuit, and the RF circuit can operate individually, which prevents the mutual impacts from causing the electronic device to operate abnormally.

Based on the concept of the present disclosure, a second aspect of the present disclosure further provides a determined method corresponding to the electronic device. The problem-solving principle of the determination method of embodiments of the present disclosure can be similar to the problem-solving principle of the electronic device. For the implementation of the determination method, reference can be made to the implementation of the electronic device, which is not repeated here.

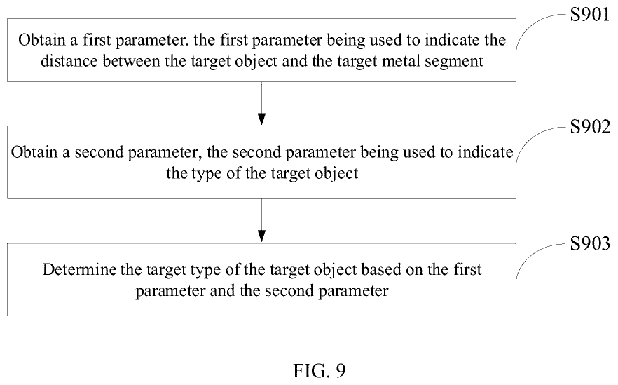

FIG. 9 illustrates a schematic flowchart of a determination method according to some embodiments of the present disclosure. The method includes the following steps.

At S901, a first parameter is obtained. The first parameter is used to indicate the distance between the target object and the target metal segment.

At S902, a second parameter is obtained. The second parameter is used to indicate the type of the target object.

At S903, the target type of the target object is determined based on the first parameter and the second parameter.

In some embodiments, if the target type of the target object is represented as the first type, the emission power of the target metal segment as the antenna radiator can be maintained. If the target type of the target object is represented as the second type, the emission power of the target metal segment as the antenna radiator can be reduced. The first type can be metal, and the second type can be non-metal.

For example, the electronic device can be a foldable cell phone. The cell phone can include a first body and a second body. The user can handheld the second body to view the content displayed on the first body. The execution body of the determination method can be the system controller of the electronic device. In some embodiments, the antenna of the second body of the foldable cell phone can be preset as the target metal segment. Then, while the electronic device operates, the capacitor sensor and the low-frequency transceiver can operate according to the predetermined cycle. That is, the capacitor sensor can provide the first sensing signal in the first time period of the predetermined cycle. The low-frequency transceiver can provide the second sensing signal in the second time period of the predetermined cycle.

When the capacitor sensor provides the first sensing signal, the low-frequency transceiver can be in the non-operation state. Then, the user can fold the unfolded first body and the second body. The system controller can obtain changes in the plurality of first parameters including the capacitance and/or the current value. Thus, the existence of the object close to the target metal segment can be determined.

Further, when the low-frequency transceiver provides the second sensing signal, the capacitor sensor can be in the non-operation state. Similarly, in the scene where the user folds the unfolded first body and the second body, the system controller may have determined the existence of the object approaching the target metal segment based on the first parameter, and further obtained the second parameter. According to the current difference between the current value of the second parameter and the current value indicated by the second sensing signal, the target type of the target object can be determined. In this scene, since the hand of the user is still relative to the first body and the second body, the target object can be determined as the first body based on the first parameter and the second parameter. That is, the target type of the target object can be metal. Then, the emission power of the target metal segment as the antenna radiator may not need to be adjusted. That is, the emission power of the target metal segment as the antenna radiator can be maintained to ensure the normal communication of the cell phone.

For another example, the folded cell phone can be arranged at the target position. When the user can fetch the cell phone, the target object approaching the target metal segment can be determined as non-metal based on the first parameter and the second parameter. For the specific determination method, reference can be made to the above description, which is not repeated here. That is, the target type of the target object can be the second type, which indicates that the target object is non-metal. The target object can be a human hand. Then, the emission power of the target metal segment as the antenna radiator can be adjusted. That is, the emission power of the target metal segment as the antenna radiator can be lowered to reduce the radiation degree of the folded cell phone to the user.

In addition, although embodiments of the present disclosure are described in the specification. The scope of the present disclosure can include any and all embodiments including equivalent elements, modifications, omissions, combinations (e.g., combinations of various embodiments), adaptations, or changes based on the present disclosure. Elements in the claims can be interpreted broadly based on the language used in the claims and should not be limited by examples described in the specification of the present disclosure. Thus, the specification and examples are intended to be merely illustrative. The actual scope and spirit can be indicated by all scopes of the following claims and equivalents of the claims.

The above description is intended to be illustrative rather than restrictive. For example, the above examples (or one or more solutions) can be used in combination with each other. For example, other embodiments can be used by those of ordinary skill in the art when reading the above description. In addition, in the above embodiments, various features can be grouped to simplify the present disclosure. This should not be interpreted as an intention that an unclaimed disclosed feature is essential to any claim. On the contrary, the subject matter of the present disclosure can be less than all features of a particular disclosed embodiment. Thus, the following claims are hereby incorporated into the implementation as examples or embodiments. Each claim can be used as an individual embodiment. These embodiments can be grouped or arranged with each other in various ways. The scope of the present disclosure should be subject to the appended claims, along with the full scope of equivalents of the claims.

A plurality of embodiments of the present disclosure are described in detail above. However, the present disclosure is not limited to these embodiments. Those skilled in the art can make various variations and modifications to embodiments of the present disclosure based on the concept of the present disclosure. These variations and modifications are within the scope of the present disclosure.

What is claimed is:

1. An electronic device comprising:
a target metal segment;
a first sensing circuit connected to the target metal segment and obtaining a first parameter based on a first sensing signal of the target metal segment, the first parameter being used to indicate a distance between a target object and the target metal segment; and
a second sensing circuit connected to the target metal segment and obtaining a second parameter based on a second sensing signal of the target metal segment, and the second parameter being used to indicate a type of the target object.

2. The device according to claim 1, wherein:
the first sensing circuit includes a first path, and the second sensing circuit includes a second path and a third path;
the first sensing circuit provides the first sensing signal to the target metal segment through the first path and monitors a change in the first sensing signal through the first path; and
the second sensing circuit provides the second sensing signal to the target metal segment through the second path and receives a feedback signal of the second sensing signal through the third path.

3. The device according to claim 2, further comprising:
a radio frequency (RF) circuit connected to the target metal segment, the target metal segment being configured to transmit an RF signal and being used as an antenna radiator of the electronic device.

4. The device according to claim 2, wherein:
the first sensing circuit includes a capacitor sensor connected to the target metal segment through the first path; and
the first path includes a resistor and a first inductive coil.

5. The device according to claim 2, wherein:
the second sensing circuit includes:
a low-frequency transceiver connected to a first end of the target metal segment through the second path and to a second end of the target metal segment through the third path; and
the second path includes a first inductive coil, the third path includes a second inductive coil, and the first inductive coil and the second inductive coil are identical.

6. The device according to claim 3, wherein the RF circuit includes:
an RF transceiver connected to the target metal segment through an RF path, the RF path including a capacitor.

7. The device according to claim 6, wherein:
the resistor is configured to allow the first sensing signal to pass through and block the second sensing signal;
the capacitor is configured to allow the RF signal to pass through and block the first sensing signal and a part of the second sensing signal;
the first inductive coil is configured to allow the first sensing signal and the second sensing signal to pass through and block the RF signal; and
the second inductive coil is configured to allow the second sensing signal to pass through and block the first sensing signal and the RF signal.

8. The device according to claim 7, wherein in response to the capacitor sensor is in an operation state, the low-frequency transceiver is in a non-operation state.

9. A determination method comprising:
obtaining a first parameter, the first parameter being used to indicate a distance between a target object and a target metal segment;
obtaining a second parameter, the second parameter being used to indicate a type of the target object; and
determining a target type of the target object based on the first parameter and the second parameter.

10. The method according to claim 9, wherein:
in response to the target type of the target object being indicated as a first type, maintaining emission power of the target metal segment; and
in response to the target type of the target object being indicated as a second type, reducing the emission power of the target metal segment.

11. The method according to claim 9, wherein:
transmitting a first sensing signal and monitoring a change in the first sensing signal; and
transmitting a second sensing signal and receiving a feedback signal of the second sensing signal.

12. The method according to claim 11, further comprising transmitting an RF signal.
